(19) United States
(12) Patent Application Publication
(10) Pub. No.: US 2026/0212455 A1
(43) Pub. Date: Jul. 23, 2026

(54) COMMUNICATION SYSTEM, COMMUNICATION APPARATUS, AND COMMUNICATION METHOD

(71) Applicant: Lenovo (Singapore) Pte. Ltd., Singapore (SG)

(72) Inventors: Seiichi Kawano, Kanagawa (JP); Shou Kuroda, Osaka (JP); Hirokazu Takata, Kyoto (JP); Qiang Yao, Kanagawa (JP)

(73) Assignee: Lenovo (Singapore) Pte. Ltd., Singapore (SG)

(21) Appl. No.: 19/367,614

(22) Filed: Oct. 23, 2025

(30) Foreign Application Priority Data
Oct. 25, 2024 (JP) 2024-188382

(51) Int. Cl. G06T 5/50; G06T 7/20; G06T 7/62; G06V 20/40

(52) U.S. Cl. CPC G06T 5/50; G06T 7/20; G06T 7/62; G06V 20/49; G06T 2207/20036; G06T 2207/20221

(57) ABSTRACT

A communication system includes at least a first apparatus and a second apparatus. The first apparatus includes: a first video processing unit which divides an original video into multi-stage elemental footages different in importance based on an aspect of a subject, and adjusts information densities of the elemental footages so that the higher the importance of a stage, the relatively higher the information density of a corresponding elemental footage will be; and a first communication processing unit which transmits the adjusted multi-stage elemental footages to the second apparatus. The second apparatus includes: a second communication processing unit which receives the adjusted multi-stage elemental footages from the first apparatus; and a second video processing unit which synthesizes the adjusted multi-stage elemental footages to reconstruct a restored video.

### CROSS-REFERENCE TO RELATED APPLICATIONS

This application claims priority to Japanese Patent Application No. 2024-188328 filed on Oct. 25, 2024, the contents of which are hereby incorporated herein by reference in their entirety.

### TECHNICAL FIELD

The present application relates to a communication system, a communication apparatus, and a communication method, which is, for example, a video communication system for having a conversation with multiple people.

### BACKGROUND

In recent years, a video communication system for sharing, among multiple points, videos acquired respectively from the multiple points has been widespread. Further, with the development of shooting equipment and communication technology, there is also a video communication system capable of realizing a high-definition video conference at which a high-definition video can be handled. Due to the high-definition video, it is expected to facilitate nonverbal communication.

However, in order to transmit a high-definition video such as 4K video, a large communication capacity (a large bandwidth in wireless communication) is required. Even when the high-definition video is compressed and encoded using a video coding format such as ITU-T H.264, the high-definition video may not be able to be transmitted as is with limited capacity. For example, an information processing apparatus disclosed in Japanese Unexamined Patent Application Publication No. 2023-155732 acquires video data shot and encoded by a camera from the camera through a network, performs decryption processing on the acquired video data, and outputs the decrypted, processed video data to a video processing application through a driver. When the amount of stored video data is a predetermined threshold value or larger, or when a difference between time information included in the latest video data and time information included in the oldest video data among stored pieces of video data is a predetermined threshold value or larger, a warning is displayed.

### SUMMARY

One or more embodiments of the present invention provide a communication system including at least a first apparatus and a second apparatus, wherein the first apparatus includes: a first video processing unit which divides an original video into multi-stage elemental footages different in importance based on the aspect of a subject, and adjusts information densities of the elemental footages so that the higher the importance of a stage, the relatively higher the information density of a corresponding elemental footage will be; and a first communication processing unit which transmits the adjusted multi-stage elemental footages to the second apparatus, and the second apparatus includes: a second communication processing unit which receives the adjusted multi-stage elemental footages from the first apparatus; and a second video processing unit which synthesizes the adjusted multi-stage elemental footages to reconstruct a restored video.

The above communication system may be such that the first video processing unit detects, from the original video, characteristic information indicative of morphological characteristics and positions of the subject, and the second video processing unit superimposes the multi-stage elemental footages so that the morphological characteristics are arranged in the positions indicated in the characteristic information to reconstruct the restored video.

The above communication system may also be such that the second video processing unit converts the multi-stage elemental footages to make the information densities equal to information density highest among the multi-stage elemental footages, and superimposes the converted multi-stage elemental footages to reconstruct the restored video.

The above communication system may further be such that the second video processing unit superimposes the multi-stage elemental footages so that an elemental footage the stage of which is higher in importance is prioritized to reconstruct the restored video.

Further, the above communication system may be such that the first video processing unit detects, from the original video, the amount of movement t of a subject in a specific aspect, and when the amount of movement is out of a range of a predetermined amount of movement, the first video processing unit determines an elemental footage indicative of the subject to be a lowest-stage elemental footage the stage of which is lowest in importance, or when the amount of movement is within the range of the predetermined amount of movement, the first video processing unit determines the elemental footage indicative of the subject to be a candidate for a high-stage elemental footage the stage of which is higher in importance than the lowest-stage elemental footage.

Further, the above communication system may be such that the first video processing unit detects, from the original video, the image size of a subject in a specific aspect, and when the size is out of a range of a predetermined size, the first video processing unit determines an elemental footage indicative of the subject to be a lowest-stage basic footage the stage of which is lowest in importance, or when the size is within the range of the predetermined size, the first video processing unit determines the elemental footage indicative of the subject to be a candidate for a high-stage elemental footage the stage of which is higher in importance than the lowest-stage elemental footage.

Further, the above communication system may be such that the subject in the specific aspect is an upper body of a person or a display medium for displaying content.

According to one or more embodiments, a communication apparatus includes: a video processing unit which divides an original video into first multi-stage elemental footages different in importance based on an aspect of a subject, and adjusts information densities of the elemental footages so that the higher the importance of a stage, the relatively higher the information density of a corresponding elemental footage will be; and a communication processing unit which transmits the adjusted first multi-stage elemental footages to another apparatus, wherein the communication processing unit receives at least second multi-stage elemental footages from the other apparatus, and the video processing unit synthesizes the second multi-stage elemental footages to reconstruct a restored video.

According to one or more embodiments, a communication method in a communication system including at least a first apparatus and a second apparatus, the communication method including: a step of causing the first apparatus to divide an original video into multi-stage elemental footages different in importance based on an aspect of a subject; a step of causing the first apparatus to adjust information densities of the elemental footages so that the higher the importance of a stage, the relatively higher the information density of a corresponding elemental footage will be; a step of causing the first apparatus to transmit the adjusted multi-stage elemental footages to the second apparatus; a step of causing the second apparatus to receive the adjusted multi-stage elemental footages from the first apparatus; and a step of causing the second apparatus to synthesize the adjusted multi-stage elemental footages to reconstruct a restored video.

One or more embodiments of the present invention can reduce the transmission capacity required for the entire system not to hinder communication.

### BRIEF DESCRIPTION OF THE DRAWINGS

FIG. 1 is a schematic block diagram illustrating a configuration example of a communication system according to one or more embodiments.

FIG. 2 is a schematic block diagram illustrating a hardware configuration example of a terminal apparatus according to one or more embodiments.

FIG. 3 is a schematic block diagram illustrating a functional configuration example of the terminal apparatus according to one or more embodiments.

FIG. 4 is a flowchart illustrating video communication processing according to one or more embodiments.

FIG. 5 is a diagram illustrating a still image extracted from an original video according to one or more embodiments.

FIG. 6 is a diagram illustrating elemental images extracted from the still image according to one or more embodiments.

FIG. 7 is a diagram illustrating a detection example of characteristic information from the still image according to one or more embodiments.

FIG. 8 is a diagram illustrating a basic still image that constructs a basic footage according to one or more embodiments.

FIG. 9 is a diagram illustrating a restored still image obtained by synthesizing the elemental image and the basic still image according to one or more embodiments.

FIGS. 10A to 10D are explanatory diagrams illustrating the synthesis of an elemental footage and the basic footage according to one or more embodiments.

FIG. 11 is a flowchart illustrating essential part determination processing according to one or more embodiments.

### DETAILED DESCRIPTION

Embodiments of the present application will be described below with reference to the accompanying drawings. A configuration example of a communication system S1 according to one or more embodiments will be described.

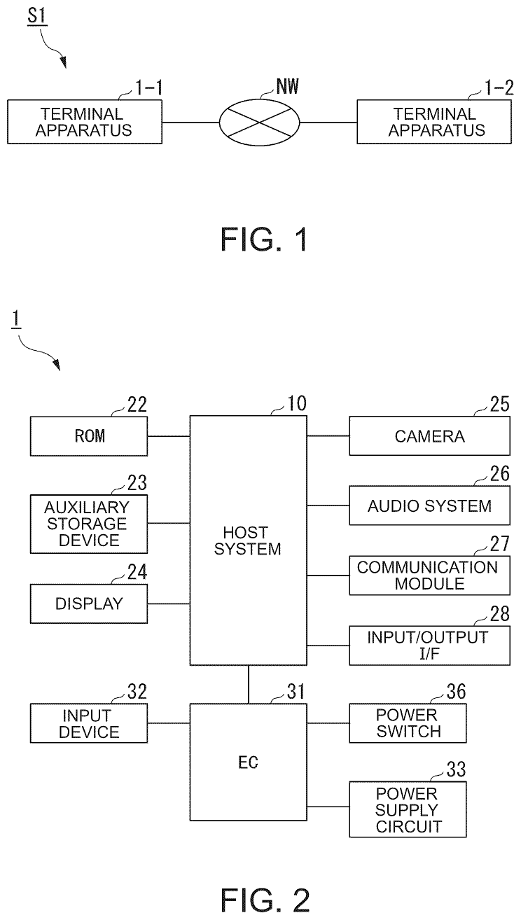

FIG. 1 is a schematic block diagram illustrating the configuration example of the communication system S1 according to according to one or more embodiments.

The communication system S1 is configured to include two or more terminal apparatuses 1. The two or more terminal apparatuses 1 are interconnected using a network NW in a manner capable of sending and receiving various data. The network NW may be any one or a combination of networks such as the Internet, a public communication network, a local area network (LAN), a virtual personal network (VPN), and a dedicated line.

In the example of FIG. 1, two terminal apparatuses 1-1 and 1-2 are illustrated. The two terminal apparatuses 1-1 and 1-2 are distinguished by assigning sub-numbers −1 and −2, respectively. In the present application, the sub-numbers may be omitted.

The number of terminal apparatuses 1 related to one communication may also be referred to as the number of connections, the number of locations, or the like. The number of connections is not limited to two, which may be an unspecified number of three or more connections, or may be fixed to a specific number of connections.

The communication system S1 is configured, for example, as a conference system, a video calling system, or the like. Video data is contained in data sent and received among the two or more terminal apparatuses 1. Using the sent and received data, communication among users of the respective terminal apparatuses 1 is facilitated. A dedicated communication server may be connected to the network NW to transmit data among the two or more terminal apparatuses 1 via the communication server.

At least any one of the two or more terminal apparatuses 1 (for example, the terminal apparatus 1-1) acquires a target video to be sent (called an “original video” in the present application). In the present application, the terminal apparatus 1 as a transmitter of the video may be called a “first apparatus.” The first apparatus divides the original video into multi-stage elemental footages different in importance based on the aspect of a subject, and adjusts information densities of the elemental footages so that the higher the importance of a stage, the relatively higher the information density of a corresponding elemental footage will be. The first apparatus transmits the adjusted multi-stage elemental footages to any other terminal apparatus (for example, the terminal apparatus 1-2). In the present application, the terminal apparatus 1 as a destination of the elemental footages may be called a “second apparatus.”

The second apparatus receives the multi-stage elemental footages from the first apparatus, and synthesizes the received multi-stage elemental footages to reconstruct a restored video. The second apparatus presents the reconstructed, restored video.

Here, the first apparatus refers to the terminal apparatus 1 as the transmitter of the video and the second apparatus refers to the terminal apparatus 1 as the destination of the video, but they do not refer to the hardware configurations and functional configurations of the individual terminal apparatuses 1. Each individual terminal apparatus 1 can meet any of the following conditions: (1) that the terminal apparatus 1 fulfills the functionality of the first apparatus but does not fulfill the functionality of the second apparatus; (2) that the terminal apparatus 1 fulfills the functionality of the second apparatus but does not fulfill the functionality of the first apparatus; and (3) that the terminal apparatus 1 fulfills both the functionality of the first apparatus and the functionality of the second apparatus. In a functional configuration example of the terminal apparatus 1 to be described later, the terminal apparatus 1 has both the functionality of the first apparatus and the functionality of the second apparatus.

Next, a hardware configuration example of the terminal apparatus 1 according to one or more embodiments will be described. FIG. 2 is a schematic block diagram illustrating the hardware configuration example of the terminal apparatus 1 according to one or more embodiments. For example, the terminal apparatus 1 may be a general-purpose information terminal apparatus such as a personal computer (PC), a tablet terminal, or a multi-function mobile phone (a so-called smartphone or the like), or may be a terminal apparatus for conference In the following description, a case where the terminal apparatus 1 is a PC is shown.

The terminal apparatus 1 includes a host system 10, a ROM (Read Only Memory) 22, an auxiliary storage device 23, a display 24, a camera 25, an audio system 26, a communication module 27, an input/output I/F (Interface) 28, an EC (Embedded Controller) 31, an input device 32, a power supply circuit 33, and a power switch 36.

The host system 10 is a computer system that constitutes the core of the terminal apparatus 1. The host system 10 is equipped with a processor, a main memory, and a chipset. In the present application, the hardware that makes up the host system 10 may be called “host devices.”

The processor is a core processing unit for controlling the entire operation of the terminal apparatus 1. The processor is, for example, a CPU (Central Processing Unit). The processor is the core processing unit for executing arithmetic processing instructed various commands written in software (program). In the present application, to execute processing instructed by commands written in a program may be referred to as “to execute a program,” “execution of a program,” and the like.

A GPU may also be included as a processor in addition to the CPU. The GPU is an arithmetic processing unit for realizing functions mainly related to image display. The GPU processes drawing commands issued from the CPU (image processing), and outputs, to the display 24, display data indicative of obtained display information. The GPU may be integrated with the CPU and formed in the same core, or may be formed in a core separated from the CPU.

The main memory is a writable memory used as a reading area of execution programs of the processor or a working area to write processed data of the execution programs. The main memory is composed, for example, of multiple DRAM (Dynamic Random Access Memory) chips. The processor and the main memory are minimum hardware that makes up the host system 10.

The chipset is equipped with plural controllers to make it possible to connect with plural devices so that various data can be input and output. The controllers equipped in the chipset 21 may be, for example, USB (Universal Serial Bus), a SPI (Serial Peripheral Interface) bus, a PCI-Express bus, and the like.

The ROM 22 mainly stores firmware. As the firmware stored in the ROM 22, there are BIOS (Basic Input-Output System) and other firmware related to individual devices.

The ROM 22 is configured to include a rewritable nonvolatile memory such as an EEPROM (Electrically Erasable Programmable Read Only Memory) or a flash ROM.

The auxiliary storage device 23 stores various data used in processing of the host system 10, various data acquired by the processing, various programs, and the like. For example, the auxiliary storage device 23 may be either an SSD (Solid State Drive) or an HDD (Hard Disk Drive).

The display 24 displays a display screen based on display data input from the host system 10. The display 24 may be, for example, either a liquid crystal display (LCD) or an OLED (Organic Light Emitting Diode) display.

The camera 25 captures images representing a subject appearing in a field of view thereof under the control of the host system 10. The camera 25 is a video camera capable of shooting a video, that is, moving images. The video is generally composed of still images at regular intervals arranged in chronological order. The camera 25 outputs, to the host system 10, video data indicative of the shot video.

The audio system 26 is equipped with an audio codec to input and output audio data. The audio codec converts an analog input audio signal input from a microphone into digital input audio data under the control of the host system 10, and outputs, to the host system 10, input audio data obtained by the conversion. The microphone detects audio propagating therethrough, and outputs, to the audio system 26, an input audio signal indicative of the detected audio. The audio codec is equipped with a decoder to convert digital output audio data output from the host system 10 into an analog output audio signal, and outputs, to a speaker, the output audio signal obtained by the conversion. The speaker presents audio based on the output audio signal input from the audio system 26.

Note that the microphone and the speaker may be equipped in the terminal apparatus 1, or either or both may be detachably connected to the terminal apparatus 1, or the microphone and the speaker may be formed as separate bodies from the terminal apparatus 1.

The communication module 27 connects various data to a communication network in a manner capable of being sent and received wirelessly or by wire. The communication module 27 communicates various data with other devices connected to the communication network. The communication module 27 is, for example, a wireless LAN module for connecting to a wireless LAN.

The input/output I/F 28 connects to various devices in a manner capable of input and output data wirelessly or by wire. The input/output I/F 28 includes, for example, a USB connector for inputting and outputting data by wire according to USB specifications.

The EC 31 is a controller that monitors and controls the operation of various devices connected thereto regardless of the operating state of the host system 10. The EC 31 includes a CPU, a ROM, a RAM, a timer, and an input/output I/F separately from those of the host system 10. To the EC 31, devices slower in data transfer speed than devices connected to the host system 10 can be connected. In the example of FIG. 2, the input device 32, the power supply circuit 33, and the power switch 36 are connected to the EC 31.

The EC 31 reads predetermined firmware form the ROM equipped therein, and executes the read firmware to provide the functionality. The firmware may also be stored in the ROM 22 in advance instead of the own ROM so that the EC 31 reads the firmware and executes the read firmware. In this case, however, the ROM 22 also needs to be started upon bootup of the EC 31.

The input device 32 detects user operations, generates an operation signal according to the user operations, and outputs the operation signal to the EC 31. For example, the input device 32 may be any of a keyboard, a touchpad, and the like.

The power supply circuit 33 includes a voltage converter and a charger. The voltage converter converts the voltage of DC power, supplied from an external power supply or a battery (not illustrated), into a voltage required for the operation of each of the devices that make up the terminal apparatus 1, and supplies power with the converted voltage to the device as a power supply destination. The power supply circuit 33 executes the supply of power to the device under the control of the EC 31.

The charger charges the battery with remaining power that is supplied from the external power supply and not consumed by each device. When no power is supplied from the external power supply, or when the power supplied from the external power supply does not meet the demand, the charger supplies, to each device, power discharged from the battery. The battery is charged with power supplied from the power supply circuit 33, or the battery discharges the stored power into the power supply circuit 33. For example, the battery may be any type of battery such as a lithium ion battery, a sodium-ion battery, or the like.

Each time a press-down operation is accepted, the power switch 36 controls the status of power supply to the host system 10 to either Power ON or Power OFF. When the press-down operation is accepted, the power switch 36 outputs, to the EC 31, a press-down signal indicative of the press-down operation. In a case where the terminal apparatus 1 is powered off, when the press-down signal is input from the power switch 36, the EC 31 causes the power supply circuit 33 to start power supply to each device of the terminal apparatus 1 (Power ON). In a case where power is being supplied to the terminal apparatus 1, when the press-down signal is input from the power switch 36, the EC 31 causes the host system 10 to execute shutdown processing (Shutdown).

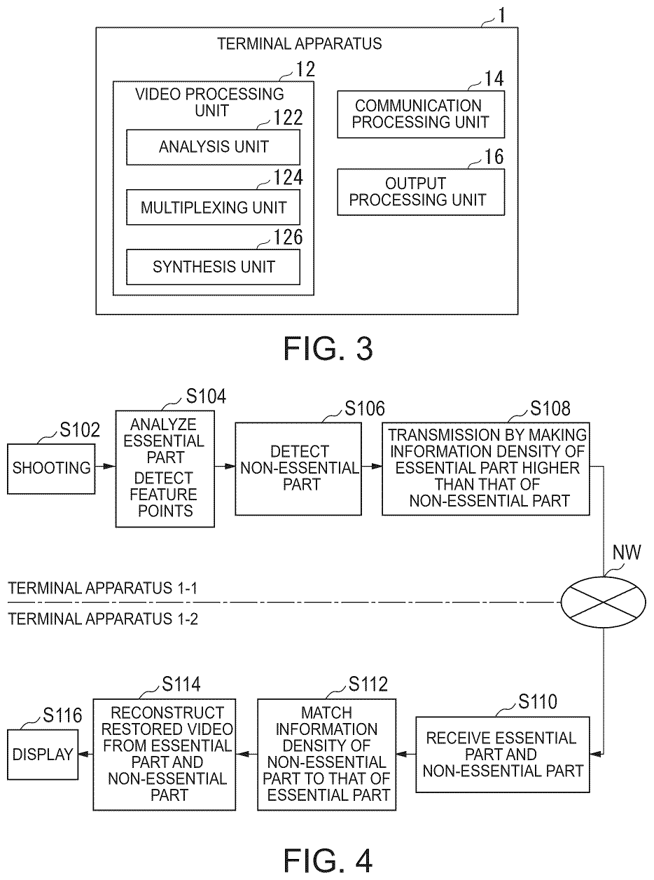

Next, a functional configuration example of the terminal apparatus 1 will be described. The functionality of the terminal apparatus 1 is realized by the processor of the host system 10 executing various programs in collaboration with the main memory and other hardware. FIG. 3 is a schematic block diagram illustrating a functional configuration example of the terminal apparatus 1 according to one or more embodiments. The terminal apparatus 1 includes a video processing unit 12, a communication processing unit 14, and an output processing unit 16. The video processing unit 12 includes an analysis unit 122, a multiplexing unit 124, and a synthesis unit 126.

Video data is input from the camera 25 (FIG. 2) to the analysis unit 122. The analysis unit 122 analyzes an original video indicated in the video data to detect a display area of a subject in a specific aspect. As the aspect of the subject, the type of subject or a combination of the type and a moving state of the subject is determined. The analysis unit 122 executes publicly known image recognition processing on the original video composed, for example, of multi-frame still images to determine the type of subject appearing in the original video and changes in the display area of the subject over time. In the image recognition processing, for example, a machine learning model such as LSTM (Long Short-Term Memory) or RNN (Recurrent Neural Network). Based on the determined aspect of the subject, the analysis unit 122 divides the original video into predetermined multi-stage elemental footages. In the analysis unit 122, stages corresponding to respect aspects of the subject are set in advance to classify each individual aspect of the subject into any stage of the multiple stages. The importance of communication between users varies in each stage.

For example, a person's face is higher in importance than other parts of the person or other subjects regardless of whether or not the subject is moving. On the person's face, specific organs, especially eyes and lips, are higher in importance than the other organs. Even among the other organs, plural parts on the moving head are higher in importance than those in a state where the head remains stationary. Changes in the relative positions of the plural parts represent a person's facial expression. Further the head, a hand, or an arm of the moving person is higher in importance than that in a state where the person remains stationary. The movement of the head, the hand, or the arm is formed as a gesture or a hand gesture. In other words, the aspect of the upper body of a person becomes a nonverbal communication clue.

Further, a display medium capable of displaying content on a display surface with user's operations is higher in importance than other subjects. This is because such a display medium can be used as a complementary aid for information transmission in video communication between users. The content to be displayed is composed of any of characters, symbols, and figures, or a combination thereof. As such a display medium, for example, there are a touch panel, a bulletin board, and the like. The touch panel may be a single unit, or may be part of an information terminal device mainly having other functions such as a smartphone. The bulletin board may be configured in any form such as a blackboard, a whiteboard, or a notebook, or the display mechanism may be electronic or non-electronic. For example, the display medium concerned may also have a display surface that represents a trajectory of writing motion (drawing input).

However, a display medium on which no content is displayed with operations is low in importance. More specifically, a display medium being held by a person's hand or for which a display surface of content is indicated may be determined to be higher in importance than a display medium not being held by the person's hand or for which no display surface of content is indicated.

Note that objects that form the background such as a wall surface, windows, and the like, equipment other than the display medium, clothes, and the like may be classified into a stage lowest in importance. This is because these objects do not contribute to communication between users. When there are plural-stage subjects lowest in importance in the original video, the analysis unit 122 may detects a set of these plural subjects as the background without distinguishing these plural subjects.

The analysis unit 122 analyzes the original video indicated in the video data to detect characteristic information indicative of predefined morphological characteristics that appear in a subject. The analysis unit 122 may explicitly contain, in the characteristic information, position information on the detected morphological characteristics.

Using a publicly known image processing technique, the analysis unit 122 detects either or both of feature points and an edge as the characteristic information. The characteristic information may be detected using a machine learning model as part of the image recognition processing, or may be detected independently. The analysis unit 122 may identify an elemental image with one or more feature points included in one subject. The analysis unit 122 may identify an elemental image with part of the edge or the whole edge included on the outer edge of one subject.

As the feature points, minute parts different in color or shade from the surroundings are detected. The feature points may also be called landmarks. The feature points correspond to a group of areas in which a number of pixels equal to or more than a certain number of pixels with the gradient of signal values thereof steeper than a predefined reference value are spatially adjacent to one another, and the gradient diameter is predetermined size or less. The signal values to be processed may be either brightness values or color signal values. As the feature points, a dimple, a pockmark, a mole, outer corners of eyes, corners of a lip, and clefts of the lip on the face are typical.

As the edge, a contour or a line with large changes in color or shading is detected. The edge corresponds to an area in which a number of pixels equal to or more than a certain number of pixels with the gradient of signal values thereof steeper than a predefined reference value are spatially adjacent to one another, a length in a particular direction is longer than a predetermined length, and a width in a direction crossing the length direction is sufficiently thinner than the length. As the edge, a jaw part that forms the bottom of the face, side edges of the head, the top of the head or a hairline, and the outer edge of a hand or an arm are typical.

The analysis unit 122 adjusts the information density of each of multi-stage elemental footages using a publicly known image processing technique so that the higher the importance of a stage, the relatively higher the information density of a corresponding elemental footage will be. The information density of a video (or a footage) is determined by the resolution, the bit depth, and the frame rate. In general, the resolution is determined by using, as an indicator, the number of pixels per frame. The larger the number of pixels per frame, the higher the information density will be. The bit depth is the number of bits that represents a signal value of each pixel. The higher the bit depth, the higher the information density will be. The frame rate corresponds to the number of frames per second. The higher the frame rate, the shorter the frame interval (period), and the higher the information density will be. However, the analysis unit 122 reduces the total amount of information on the multi-stage elemental footages to be less than the amount of information on the original video. Therefore, the lower the importance of a stage, the higher the information density reduction rate will be.

The analysis unit 122 outputs, to the multiplexing unit 124, the multi-stage elemental footages and the characteristic information.

The multiplexing unit 124 multiplexes the respective elemental footages and the characteristic information input from the analysis unit 122.

The multiplexing unit 124 performs encoding processing on each of the multi-stage elemental footages using a predetermined video coding format to generate encoded data. As the predetermined video coding format, for example, the multiplexing unit 124 can use a format specified in ITU-T H.264 (AVC: Advanced Video Coding), a format specified in ITU-T H.265 (VVC: Versatile Video Coding), or the like. The multiplexing unit 124 performs multiplexing including respective pieces of multi-stage encoded data and characteristic information by associating these pieces of data with one another to generate multiplexed data. The multiplexing unit 124 outputs the generated multiplexed data to the communication processing unit 14. The output multiplexed data is transmitted to a terminal apparatus 1 as a destination (which may also be called a “destination apparatus” in the present application) using the communication processing unit 14.

To the synthesis unit 126 of the destination apparatus, the received multiplexed data is input from the communication processing unit 14. The synthesis unit 126 separates, from the input multiplexed data, the respective pieces of multi-stage encoded data and characteristic information. The synthesis unit 126 performs decryption processing on each of the separated pieces of multi-stage encoded data using a predetermined video decoding format to restore each elemental footage. The video decoding format may be any format corresponding to the video coding format used for conversion to the encoded data.

The synthesis unit 126 identifies positions corresponding to the positions indicated in the characteristic information so that the morphological characteristics of the subject are arranged in the positions, and superimposes the multi-stage elemental footages to reconstruct a restored video. Before superimposing the multi-stage elemental footages, the synthesis unit 126 converts the multi-stage elemental footages using a publicly known image processing technique in a manner to commonize the information densities thereof in one way, and acquires, as the converted elemental footages, the elemental footages after being converted. The synthesis unit 126 spatially and temporally interpolates a signal value of each pixel of an elemental image in each of frames that construct a certain first-stage elemental footage so that the resolution, the bit depth, and the frame rate of the first-stage elemental footage per unit area becomes equal to the resolution, the bit depth, and the frame rate of a second-stage elemental footage higher in importance than the first-stage elemental footage. As the information density after being commonized in one way, for example, the highest information density among the multi-stage information densities may be applied. By matching the information densities between stages in one way, it becomes easier to manipulate a pixel value for each pixel in each frame. Further, it is convenient to identify the position of an elemental footage based on the morphological characteristics.

An area of the converted first-stage elemental footage the position of which is identified may overlap with an area of a part of the converted second-stage elemental footage as another stage. Therefore, upon superimposing the converted multi-stage elemental footages the positions of which are identified, the synthesis unit 126 gives priority to a converted stage elemental footage higher in importance. In other words, when signal values are set for a certain pixel in converted two or more stage elemental footages, respectively, the synthesis unit 126 a signal value related to a converted elemental image in a stage the importance of which is highest is adopted, and the signal values related to the other elemental images are discarded. In this case, the synthesis unit 126 has only to overwrite converted elemental footages in higher stages sequentially on a converted elemental footage in a stage the importance of which is lowest.

Note that, in the video coding format and the video decoding format exemplified above, footages having a rectangular area can be encoded and decoded, but footages having any other shape cannot be processed. Therefore, footages having a rectangular area in which the subject is inscribed are targeted for being processed. However, this case may make the user feel uncomfortable by visually identifying a gap between the rectangular area related to the superimposed elemental footage and the subject in the restored video.

Therefore, the synthesis unit 126 may perform image recognition processing on the rectangular area including an elemental image higher in importance than that in the lowest stage to extract elemental footages that represent the subject so as to eliminate the gap between the subject and the rectangular area. Using the above technique, the synthesis unit 126 superimposes the extracted elemental footages to synthesize a restored video. Thus, the gap between the rectangular area and the subject no longer appears in the restored video.

The synthesis unit 126 outputs, to the output processing unit 16, video data indicative of the synthesized, restored video.

The communication processing unit 14 is connected to the network NW to identify a terminal apparatus 1 as the destination apparatus. The destination apparatus may be identified using any identification information such as URL (Universal Resource Locator) or SIP-URI (Session Initiation Protocol-Universal Resource Identifier).

For example, when a connection request is input from the destination apparatus to the own apparatus, the communication processing unit 14 displays, on the display 24, an inquiry screen to inquire whether or not to allow the connection with the destination apparatus. When an allow button arranged on the inquiry screen is instructed by an operation signal input from the input device 32, the communication processing unit 14 determines that the connection is allowed. Then, the communication processing unit 14 transmits a confirmation response to the destination apparatus as the transmitter of the connection request. At this time, a connection is established between the own apparatus and the destination apparatus.

When a reject button placed on the inquiry screen is instructed by an operation signal input from the input device 32, or when the allow button is not instructed even after a predetermined waiting time has elapsed since the display of the inquiry screen, the communication processing unit 14 determines that the connection is refused. Then, the communication processing unit 14 transmits a rejection response to the destination apparatus as the transmitter of the connection request. At this time, the own apparatus does not establish the connection with the destination apparatus.

Note that the output processing unit 16 may display, on the display 24, an operation screen for identifying the destination apparatus and instructing to start communication. At this time, the communication processing unit 14 may accept an operation signal indicative of a connection request from the input device 32 to the destination apparatus. When the operation signal indicative of the connection request is input from the input device 32, the communication processing unit 14 transmits the connection request to the destination apparatus instructed by the operation signal. When receiving a confirmation response to the connection request from the destination apparatus, the communication processing unit 14 determines that the connection with the destination apparatus is allowed. At this time, a connection between the own apparatus and the destination apparatus is established. When receiving a rejection response to the connection request from the destination apparatus, or when no confirmation response is received even after a predetermined waiting time has elapsed since the connection request was transmitted, the communication processing unit 14 determines that the connection with the destination apparatus is not allowed. At this time, the own apparatus does not establish the connection with the destination apparatus.

The communication processing unit 14 transmits and receives communication data with the destination apparatus in a state where the connection with the destination apparatus is established.

The communication processing unit 14 transmits, to the destination apparatus, the multiplexed data input from the video processing unit 12.

The communication processing unit 14 may transmit, to the destination apparatus, the multiplexed data by containing therein either or both of audio data input from the audio system 26 and app screen data indicative of a screen (which may also be called an “app screen” in the present application) obtained by executing any other application program (which may also be called an “app” in the present application). The app may provide a function such as a chat function, a document display function, or the like.

When receiving the multiplexed data from the destination apparatus, the communication processing unit 14 outputs the received multiplexed data to the synthesis unit 126. When audio data is multiplexed in the received multiplexed data, the communication processing unit 14 separates the audio data from the multiplexed data, and outputs the separated audio data to the audio system 26 via the output processing unit 16. When the app screen data is multiplexed in the received multiplexed data, the communication processing unit 14 separates the app screen data from the multiplexed data, and outputs the separated app screen data to the output processing unit 16.

The output processing unit 16 executes processing for outputting various information related to communication with the destination apparatus. The output processing unit 16 configures a display screen containing the restored video indicated in the video data input from the synthesis unit 126. The output processing unit 16 outputs, to the display 24, display data indicative of the configured display screen. On the display 24, the display screen containing the restored video is displayed based on the display data.

When the app screen data is input from the communication processing unit 14, the output processing unit 16 may also configure a display screen containing the app screen indicated in the app screen data.

When the audio data is input from the communication processing unit 14, the output processing unit 16 may output the input audio data to the audio system 26 to present audio from the speaker.

The output processing unit 16 may output, to the display 24, display data indicative of a screen for various settings.

Next, video communication processing according to one or more embodiments will be described. FIG. 4 is a flowchart illustrating the video communication processing according to one or more embodiments. In the video communication processing illustrated in FIG. 4, a series of processes from shooting an original video on the terminal apparatus 1-1 until the terminal apparatus 1-2 displays a restored video is illustrated. The following description will be made mainly in a case where the number of stages of elemental footages is two stages. A stage lowest in importance may be called the “lowest stage,” a subject or an image of the subject related to the lowest stage may be called a “non-essential part, ” and a footage representing the non-essential part may be called a “non-essential part footage.” Further, a stage higher in importance than the lowest stage may be called a “high stage,” a subject or an image of the subject related to the high stage may be called an “essential part,” and a footage representing the essential part may be called an “essential part footage.”

The number of essential part footages detected from the original video is not necessarily limited to one, which may be two or more, or may be 0.

The terminal apparatus 1-1 executes processes from step S102 to step S108.
(Step S102) The camera 25 shoots a video.
(Step S104) The analysis unit 122 sets the video shot by the camera 25 as an original video, and detects an elemental footage, in which a specific type of subject is contained as an essential part, from the original video using a predetermined model. Further, the analysis unit 122 detects feature points indicative of predetermined morphological characteristics of the subject from the original video.
(Step S106) The analysis unit 122 detects an elemental footage indicative of a non-essential part from the original video using a model different from that used for detecting the essential part.
(Step S108) The analysis unit 122 makes the essential part footage indicative of the essential part higher in information density than the non-essential part footage indicative of the non-essential part, and the communication processing unit 14 transmits multiplexed data, in which respective encoded data of the essential part footage and the non-essential part footage, and characteristic information indicative of feature points are multiplexed, to the terminal apparatus 1-2 using the network NW.

The terminal apparatus 1-2 executes processes from step S110 to step S116.
(Step S110) The communication processing unit 14 receives the multiplexed data from the terminal apparatus 1-1. The synthesis unit 126 separates, from the multiplexed data, the respective encoded data of the essential part footage and the non-essential part footage, and the characteristic information indicative of the feature points.
(Step S112) The synthesis unit 126 adjusts the information density of the non-essential part footage to make it equal to the information density of the essential part footage.
(Step S114) The synthesis unit 126 superimposes the essential part footage on the non-essential part footage after being adjusted so that the feature points of the essential part footage are placed in positions indicated in the characteristic information to reconstruct a restored video.
(Step S116) The output processing unit 16 displays, on the display 24, the reconstructed, restored video. After that, the processing of FIG. 4 is ended.

Note that the transmission of footages may also be performed from the terminal apparatus 1-2 to the terminal apparatus 1-1 in the communication system S1. In that case, the terminal apparatus 1-2 performs the processes from step S102 to step S108, and the terminal apparatus 1-1 performs the processes from step S110 to step S116.

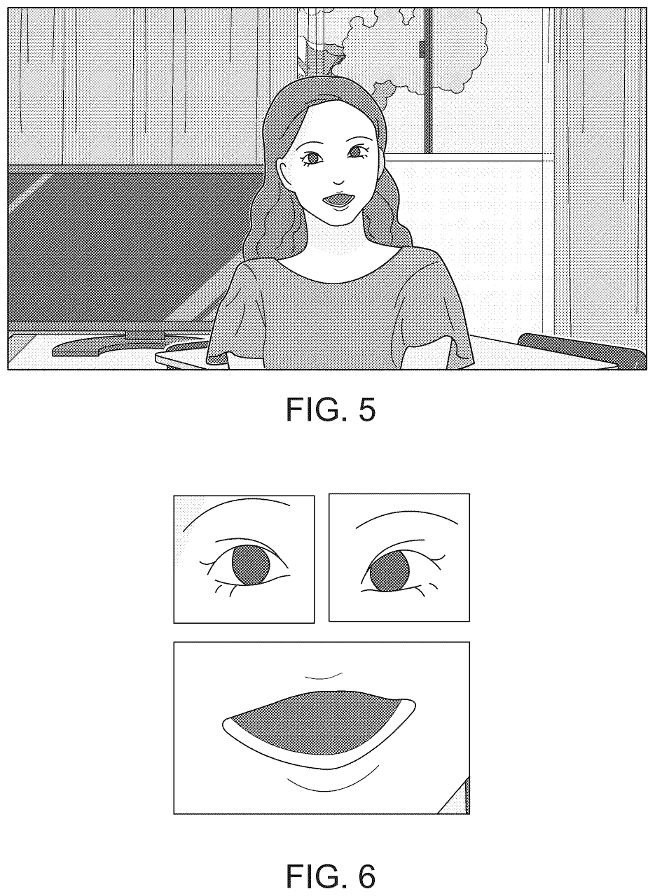

Next, a video footage or image processing example is illustrated. FIG. 5 illustrates a still image that constructs one frame of an original video. The still image illustrated in FIG. 5 is captured by the camera 25 of the terminal apparatus 1-1 while communicating with the terminal apparatus 1-2. This still image illustrates the fronts of the head and chest of a user of the terminal apparatus 1-1 at a certain time, respectively.

FIG. 6 illustrates still images that construct an essential part footage. The illustrated still images represent the left eye and right eye, and the lips on the face of the user respectively as essential parts detected by the analysis unit 122 from the still image in FIG. 5. The left eye, the right eye, and the lips are organs each of which varies in shape and position depending on user emotions. These organs tend to attract attention from a partner in the communication. In the essential footage, since a decrease in information density is prevented or mitigated unlike in a non-essential footage, communication is not hindered.

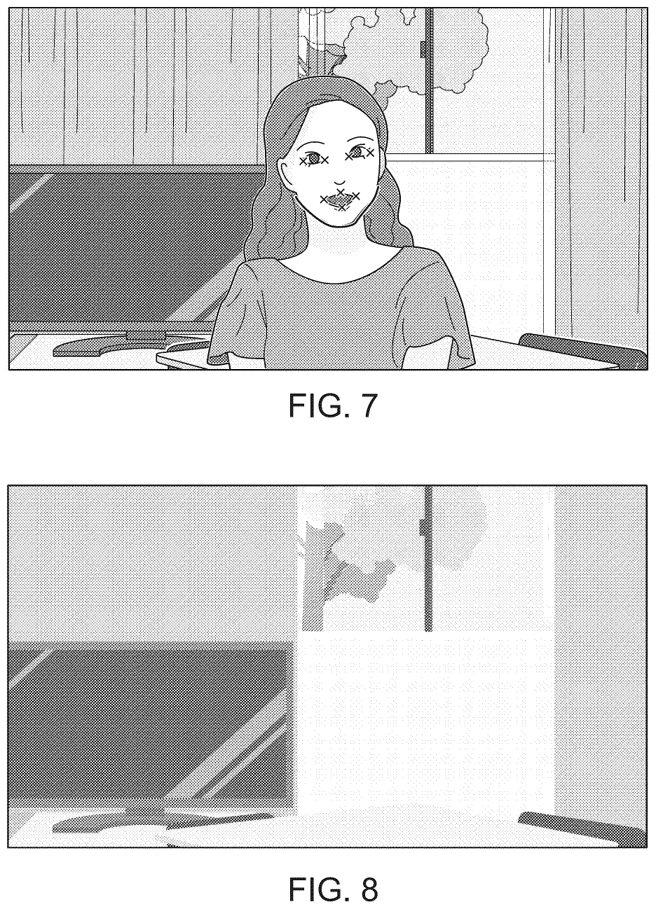

FIG. 7 illustrates a detection example of characteristic information from the original image. In the illustrated characteristic information, feature points and an edge detected from the still image illustrated in FIG. 5 are contained. As the feature points, the outer corners of both eyes, and the corners and clefts of the lips are marked with a cross, respectively. As the edge, the outer edge of the bottom of the face containing a chin is depicted by a curve.

FIG. 8 illustrates a still image that constructs a non-essential footage. The illustrated still image is detected by the analysis unit 122 from the original video, and the resolution of the still image is lower than that of the essential footage. The illustrated still image represents a background composed mainly of windows. Since the background does not get attention from a user of the destination apparatus, the information density of the non-essential footage lower than that of the essential footage is allowed.

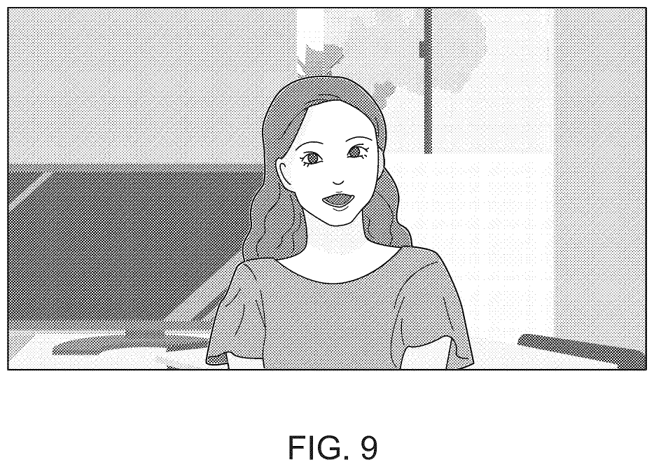

FIG. 9 illustrates a still image that constructs one frame of a restored image. The illustrated restored image can be obtained by superimposing the essential footage on the non-essential footage in the synthesis unit 126. The essential footage is superimposed on the non-essential footage in such a manner that the feature points of the essential footage are placed in positions indicated in the characteristic information.

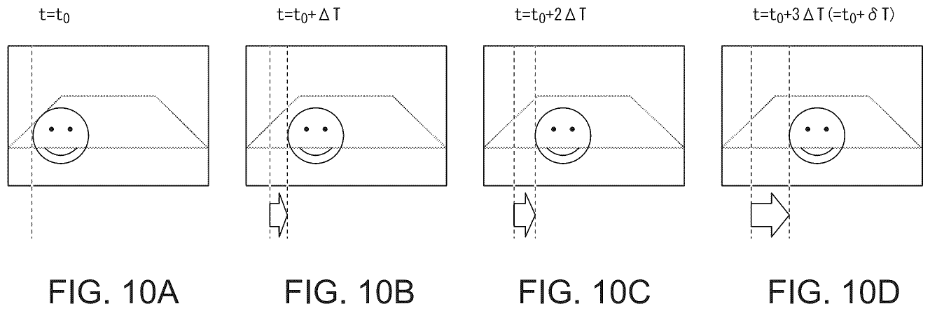

Next, a specific example of synthesis of an essential part footage and a non-essential part footage will be described. FIGS. 10A to 10D are explanatory diagrams illustrating the synthesis of the essential part footage and the non-essential part footage. Note that a case where the essential part footage is transmitted at a rate three times the frame rate of the non-essential part footage is illustrated. A still image in each of frames that construct the non-essential part footage is so interpolated that the frame rate will be tripled in the synthesis unit 126. When interpolating still images, the synthesis unit 126 may repeat each of the still images that construct the non-essential footage three times in a frame period equal to that of the essential footage, or may perform morphing to carry out the generation using the still images frame by frame. FIGS. 10A to 10D illustrate a non-essential part image and an essential part image in each frame during time t=t₀ to t₀+3ΔT (=t₀+δT, where ΔT and δT indicate a frame interval of the essential part footage and the non-essential part footage, respectively) with a thin dotted line and a thick line, respectively. As a morphological characteristic of the essential part footage, the edge that constructs the outline of the essential part is used. The still images that construct the essential part footage is superimposed on the still images that construct the non-essential part footage in such a manner that the outline of the essential part is placed in positions indicated in the characteristic information. FIGS. 10A to 10D illustrate that a subject appearing in the essential part footage moves sequentially to the right during the time t=t₀ to t₀+3ΔT. Therefore, even when the essential part footage and the non-essential part footage are different in frame rate, the movement of the subject depicted in the essential part footage on the non-essential part footage with the frame rate adjusted is smoothly reproduced.

Note that the essential part determined uniformly based on the type of subject does not necessarily contribute to information transmission between users. Therefore, the analysis unit 122 may also determine, to be a non-essential part, a subject whose amount of movement between frames is a reference value for a predetermined amount of movement or larger. This is because not only is it difficult to recognize the deterioration of the image quality of a subject moving fast even when the information density is reduced, but also such a subject does not contribute to precise information transmission. Further, the analysis unit 122 may exclude a subject the size of which is out of a predetermined range, and determine a subject the size of which is within the predetermined range as an essential part candidate.

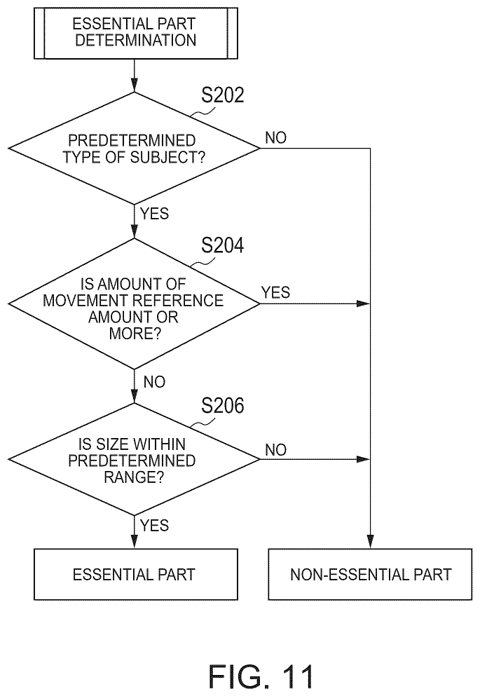

Next, an example of essential part determination processing will be described using FIG. 11. FIG. 11 is a flowchart illustrating essential part determination processing according to one or more embodiments.
(Step S202) The analysis unit 122 identifies a subject that appears in the original video acquired from the camera 25. When the identified subject is a predetermined type of subject (step S202→YES), the analysis unit 122 proceeds to a process in step S204. When the identified subject is of a type different from the predetermined type (step S202→NO), the analysis unit 122 determines a display area of the subject to be a non-essential part, and ends the processing in FIG. 11.
(Step S204) When the amount of movement of the predetermined type of subject from the subject appearing in the previous frame is equal to or more than a predetermined reference amount (step S204 >YES), the analysis unit 122 determines the display area of the subject to be the essential part, and ends the processing in FIG. 11. When the amount of movement is less than the predetermined reference amount (step S204→NO), the analysis unit 122 proceeds to a process in step S206.
(Step S206) The analysis unit 122 determines whether or not the size of the predetermined type of subject is within a predetermined size range (for example, 1/32 to 1/64 of one side of the display screen). When the size is within the predetermined range (step S206→YES), the analysis unit 122 determines an image of the subject to be the essential part. After that, the processing in FIG. 11 is ended. When the size is smaller or larger than the predetermined range (step S206→NO), the analysis unit 122 determines the display area of the subject to be the non-essential part, and the processing in FIG. 11 is ended.

Note that, when a high-definition video is encoded as is and transmitted as described at the beginning, a large transmission capacity (that is, a large bandwidth) is required. When a 4K video (3840×2160 pixel) is encoded based on the format specified in ITU-T H.264 and transmitted at 30 frames per second, the required communication capacity is 16 Mbps. However, in one or more embodiments, since the 4K video as an original video is divided into an essential part footage and a non-essential part footage, and the information density of the non-essential part footage is reduced from that of the original video without reducing the information density of the essential part footage from the original video, the communication capacity of the entire video can be reduced without significantly reducing subjective quality. For example, when the video is encoded and transmitted by setting the number of pixels of the essential part footage that constructs part of a one-frame area to 540×960 pixel and the frame rate to 30 frames per second, and setting the number of pixels of the non-essential part footage to 240×135 pixel and the frame rate to 10 frames per second, required transmission capacities are 1 Mbps for the essential part footage and 0.2 Mbps for the non-essential part footage. Since the overall transmission Capacity is 1.2 Mbps, it is just a transmission capacity of 1/12 or less of that required for transmitting the 4K video as is.

In the above description, the example in which the number of connections in the communication system S1 is 2 and the communication system S1 is applied to communication involving the transmission of video data between the two terminal apparatuses 1 is mainly given, but the communication system S1 is not limited to this example. The communication system S1 may also be such that the number of connections is 3 or more and the communication system S1 is applied to communication among three or more terminal apparatuses 1. In this case, at least any one of the three or more terminal apparatuses 1 is the first apparatus, and the other two or more terminal apparatuses are second apparatuses, where the first apparatus transmits common multiplexed data based on a video acquired on the own apparatus to the second apparatuses, respectively. The first apparatus receives, from the respective second apparatuses, multiplexed data based on videos acquired on the individual second apparatuses. The first apparatus can synthesize restored videos based on the respective pieces of multiplexed data. The first apparatus may arrange and present all of the synthesized restored videos in parallel, or may present some of the restored videos. Using the above technique, the communication processing unit 14 can identify the three or more terminal apparatuses 1 participating in one communication.

The analysis unit 122 may reduce the amount of information on the multiplexed data per transmitter apparatus as the number of connections of the terminal apparatuses participating in one communication increases. Here, the analysis unit 122 may reduce the information density of a non-essential part footage or reduce the information density of an essential part footage as the number of connections increases. In the analysis unit 122, subject types as multi-stage essential part candidates may be preset, and a subject range as essential part candidates may be narrowed as the number of connections increases. When the number of connections exceeds a predefined upper limit of the number of connections, the analysis unit 122 may convert the entire original video to a non-essential part footage without performing essential part analysis to stop the transmission of an essential part footage.

The communication processing unit 14 may determine the presence or absence of speech using a publicly known audio processing technique based on audio data input to the own unit. The communication processing unit 14 may transmit multiplexed data based on a video acquired in a speech period determined to be speaking, and may stop the transmission of multiplexed data based on a video acquired in a non-speech period determined not to be speaking. Further, the communication processing unit 14 may set the entire original video as a non-essential part footage in the speech period to stop the transmission of an essential part footage.

As described above, the communication system S1 according to one or more embodiments includes at least the first apparatus (for example, the terminal apparatus 1-1) and the second apparatus (for example, the terminal apparatus 1-2). The first apparatus includes: a first video processing unit (for example, the analysis unit 122 of the video processing unit 12) which divides an original video into multi-stage elemental footages different in importance based on the aspect of a subject, and adjusts information densities of the elemental footages so that the higher the importance of a stage, the relatively higher the information density of a corresponding elemental footage will be; and a first communication processing unit (for example, the communication processing unit 14) which transmits the adjusted multi-stage elemental footages to the second apparatus. The second apparatus includes: a second communication processing unit (for example, the communication processing unit 14) which receives the adjusted multi-stage elemental footages from the first apparatus; and a second video processing unit (for example, the synthesis unit 126 of the video processing unit 12) which synthesizes the adjusted multi-stage elemental footages to reconstruct a restored video and output the restored video.

A specific type of subject may be the upper body (for example, the head, a hand, an arm, and the like) of a person, or a display medium (for example, a touch panel, a bulletin board, or the like) for displaying content.

According to this configuration, an elemental footage the information density of which is reduced according to the importance is transmitted from the first apparatus to the second apparatus, and the restored video reconstructed by synthesizing, on the elemental footage, another elemental footage between multiple stages is output. Since the information density of a subject important for communication can be relatively increased while reducing the communication capacity required for the entire communication system S1 to ensure quality, smooth communication through video communication between the first apparatus and the second apparatus can be maintained.

The above communication system S1 may be such that the first video processing unit detects, from the original video, characteristic information indicative of predetermined morphological characteristics (for example, feature points and an edge) and positions of the subject, and the second video processing unit superimposes the multi-stage elemental footages so that the morphological characteristics are arranged in the positions indicated in the characteristic information to reconstruct the restored video.

According to this configuration, a position in which each elemental footage that constructs part of the video to be transmitted is superimposed is identified using, as a clue, the morphological characteristic indicated in the characteristic information. Further, processing efficiency can be improved by skipping the process of analyzing the characteristic information in the second video processing unit.

The above communication system S1 may also be such that the second video processing unit converts the multi-stage elemental footages to make the information densities equal to information density highest among the multi-stage elemental footages, and superimposes the converted multi-stage elemental footages to reconstruct the restored video.

According to this configuration, the information densities are commonized between the multi-stage elemental footages to make the information densities equal to information density highest among the multi-stage elemental footages. Therefore, the processing load related to the superimposition of the multi-stage elemental footages can be reduced to ensure the quality of the restored video.

The above communication system S1 may further be such that the second video processing unit superimposes the multi-stage elemental footages so that an elemental footage the stage of which is higher in importance is prioritized to reconstruct the restored video.

According to this configuration, even when the elemental footages are overlapped between the multiple stages, the elemental footage the stage of which is higher in importance is reflected in the restored video. Further, quality degradation due to a lack of information by overlapping of the elemental footages can be reduced.

Further, the above communication system S1 may be such that the first video processing unit detects, from the original video, the amount of movement of a subject in a specific aspect, and when the amount of movement is out of a range of a predetermined amount of movement, the first video processing unit determines an elemental footage indicative of the subject to be a lowest-stage elemental footage the stage of which is lowest in importance, or when the amount of movement is within the range of the predetermined amount of movement, the first video processing unit determines the elemental footage indicative of the subject to be a candidate for a high-stage elemental footage the stage of which is higher in importance than the lowest-stage elemental footage.

According to this configuration, among subjects in specific aspects, an image of a subject whose amount of movement is within the predetermined range becomes a candidate for a high-stage elemental footage, and an image of a subject whose amount of movement exceeds the predetermined range becomes the lowest-stage elemental footage. Since the information density of the image of the subject whose amount of movement exceeds the predetermined range and does not contribute to communication is set to the lowest stage, the transmission capacity can be reduced without hindering communication.

Further, the above communication system S1 may be such that the first video processing unit detects, from the original video, an image size of a subject in a specific aspect, and when the size is out of a range of a predetermined size, the first video processing unit determines an elemental footage indicative of the subject to be a lowest-stage basic footage the stage of which is lowest in importance, or when the size is within the range of the predetermined size, the first video processing unit determines the elemental footage indicative of the subject to be a candidate for a high-stage elemental footage the stage of which is higher in importance than the lowest-stage elemental footage.

According to this configuration, the image of a subject the size of which is within a specific range becomes a candidate for a high-stage elemental footage, and the image of a subject the size of which exceeds the predetermined range becomes the lowest-stage elemental footage. Since the information density of the image of the subject the size of which exceeds the predetermined range and does not contribute to communication is set to the lowest stage, the transmission capacity can be reduced without hindering communication.

While embodiments of the present application have been described in detail above with reference to the accompanying drawings, the specific configurations are not limited to those of the embodiments described above, and design changes and the like without departing from the scope of this invention are included. The respective configurations in the embodiments described above can be combined arbitrarily.

### DESCRIPTION OF SYMBOLS

S1 communication system
1 (1-1, 1-2) terminal apparatus
10 host system
12 video processing unit
14 communication processing unit
16 output processing unit
22 ROM
23 auxiliary storage device
24 display
25 camera
26 audio system
27 communication module
28 input/output I/F
31 EC
32 input device
33 power supply circuit
36 power switch
122 analysis unit
124 multiplexing unit
126 synthesis unit
NW network

What is claimed is:

1. A communication system including at least a first apparatus and a second apparatus, wherein
the first apparatus comprises:
a first video processing unit which divides an original video into multi-stage elemental footages different in importance based on an aspect of a subject, and adjusts information densities of the elemental footages so that the higher the importance of a stage, the relatively higher the information density of a corresponding elemental footage will be; and
a first communication processing unit which transmits the adjusted multi-stage elemental footages to the second apparatus, and
the second apparatus comprises:
a second communication processing unit which receives the adjusted multi-stage elemental footages from the first apparatus; and
a second video processing unit which synthesizes the adjusted multi-stage elemental footages to reconstruct a restored video.

2. The communication system according to claim 1, wherein
the first video processing unit detects, from the original video, characteristic information indicative of morphological characteristics and positions of the subject, and
the second video processing unit superimposes the multi-stage elemental footages so that the morphological characteristics are arranged in the positions indicated in the characteristic information to reconstruct the restored video.

3. The communication system according to claim 2, wherein the second video processing unit converts the multi-stage elemental footages to make the information densities equal to information density highest among the multi-stage elemental footages, and superimposes the converted multi-stage elemental footages to reconstruct the restored video.

4. The communication system according to claim 3, wherein the second video processing unit superimposes the multi-stage elemental footages so that an elemental footage the stage of which is higher in importance is prioritized to reconstruct the restored video.

5. The communication system according to claim 3, wherein
the first video processing unit detects, from the original video, an amount of movement of a subject in a specific aspect, and
when the amount of movement is out of a range of a predetermined amount of movement, the first video processing unit determines an elemental footage indicative of the subject to be a lowest-stage elemental footage the stage of which is lowest in importance, or
when the amount of movement is within the range of the predetermined amount of movement, the first video processing unit determines the elemental footage indicative of the subject to be a candidate for a high-stage elemental footage the stage of which is higher in importance than the lowest-stage elemental footage.

6. The communication system according to claim 3, wherein
the first video processing unit detects, from the original video, an image size of a subject in a specific aspect, and
when the size is out of a range of a predetermined size, the first video processing unit determines an elemental footage indicative of the subject to be a lowest-stage basic footage the stage of which is lowest in importance, or
when the size is within the range of the predetermined size, the first video processing unit determines the elemental footage indicative of the subject to be a candidate for a high-stage elemental footage the stage of which is higher in importance than the lowest-stage elemental footage.

7. The communication system according to claim 5, wherein the subject in the specific aspect is an upper body of a person or a display medium for displaying content.

8. A communication apparatus comprising:
a video processing unit which divides an original video into first multi-stage elemental footages different in importance based on an aspect of a subject, and adjusts information densities of the elemental footages so that the higher the importance of a stage, the relatively higher the information density of a corresponding elemental footage will be; and
a communication processing unit which transmits the adjusted first multi-stage elemental footages to another apparatus, wherein
the communication processing unit receives at least second multi-stage elemental footages from the other apparatus, and
the video processing unit synthesizes the second multi-stage elemental footages to reconstruct a restored video.

9. A communication method in a communication system including at least a first apparatus and a second apparatus, the communication method comprising:
a step of causing the first apparatus to divide an original video into multi-stage elemental footages different in importance based on an aspect of a subject;
a step of causing the first apparatus to adjust information densities of the elemental footages so that the higher the importance of a stage, the relatively higher the information density of a corresponding elemental footage will be;
a step of causing the first apparatus to transmit the adjusted multi-stage elemental footages to the second apparatus;
a step of causing the second apparatus to receive the adjusted multi-stage elemental footages from the first apparatus; and
a step of causing the second apparatus to synthesize the adjusted multi-stage elemental footages to reconstruct a restored video.
